(19) United States
(12) Patent Application Publication
(10) Pub. No.: US 2020/0320613 A1
(43) Pub. Date: Oct. 8, 2020

(54) System and Method for Processing Orders in a Multi-Kitchen Environment

(71) Applicant: City Storage Systems, Los Angeles, CA (US)

(72) Inventors: Victor-Benjamin Broca, Los Angeles, CA (US); Nadir Hyder, Los Angeles, CA (US); Diego Berdakin, Los Angeles, CA (US); John Gaa, Culver City, CA (US)

(21) Appl. No.: 16/396,175

(22) Filed: Apr. 26, 2019

Related U.S. Application Data
(60) Provisional application No. 62/830,980, filed on Apr. 8, 2019.

(51) Int. Cl. G06Q 30/06; G06Q 10/06; G06Q 10/08; G06Q 50/12; G06K 19/06

(52) U.S. Cl. CPC G06Q 30/0635; G06Q 10/06316; G06K 19/06037; G06Q 50/12; G06Q 10/0835

(57) ABSTRACT

A method for processing a customer food order in a multi-kitchen environment, including receiving an order having at least first and second food items, translating an identifier of the first food item to a first corresponding identifier associated with a first kitchen and routing the first corresponding identifier to the first kitchen, translating an identifier of the second food item to a second corresponding identifier associated with a second kitchen and routing the second corresponding identifier to the second kitchen, receiving a notification that the first food item is located at one of a plurality of delivery storage locations, and receiving a notification that the second food item is prepared for storage, and in response transmitting the delivery storage location of the first food item.

### CROSS REFERENCE TO RELATED APPLICATIONS

The present application claims the benefit of U.S. provisional patent application No. 62/830,980 filed on Apr. 8, 2019, the disclosure of which is incorporated in its entirety herein by reference.

### BACKGROUND

Presently, there is a need to process food orders placed by consumers to restaurants and related commercial kitchens via online food ordering services. A food facility may house multiple commercial kitchens, each associated with one or more restaurants. Each kitchen may receive food orders from consumers via one or more online ordering food services. The food facility may need to manage the incoming food orders for the kitchens and manage the prepared food for delivery. The system and method of the present disclosure performs those functions and more.

### SUMMARY OF THE INVENTION

A method for processing a customer food order in a multi-kitchen environment, including receiving an order having at least first and second food items, translating an identifier of the first food item to a first corresponding identifier associated with a first kitchen and routing the first corresponding identifier to the first kitchen, translating an identifier of the second food item to a second corresponding identifier associated with a second kitchen and routing the second corresponding identifier to the second kitchen, receiving a notification that the first food item is located at one of a plurality of delivery storage locations, and receiving a notification that the second food item is prepared for storage, and in response transmitting the delivery storage location of the first food item.

### BRIEF DESCRIPTION OF THE DRAWINGS

The detailed description is set forth with reference to the accompanying drawings, which are not necessarily drawn to scale. The use of same reference numbers in different figures indicate similar or identical terms.

FIG. 1 is illustrates a flow chart according to an aspect of the invention of the present disclosure.

FIG. 2 illustrates a system and data flow from user to server according to an aspect of the invention of the present disclosure.

FIG. 3 illustrates a system and data flow from server to kitchen according to an aspect of the invention of the present disclosure.

FIG. 4 illustrates a lookup table according to an aspect of the invention of the present disclosure.

FIG. 5 illustrates a system and order data according to an aspect of the invention of the present disclosure.

FIG. 6 is illustrates a flow chart according to an aspect of the invention of the present disclosure.

FIG. 7 is illustrates a flow chart according to an aspect of the invention of the present disclosure.

### DETAILED DESCRIPTION OF THE INVENTION

In order that the present invention may be fully understood and readily put into practical effect, there shall now be described by way of non-limitative examples only preferred embodiments of the present invention, the description being with reference to the accompanying illustrative figures.

A multi-kitchen facility may be a building with two or more commercial kitchens, each operated by or associated with one or more restaurants. Aspects of the invention of the present application may be used in a single kitchen within a single restaurant or may be used in a multi-kitchen facility where each kitchen.

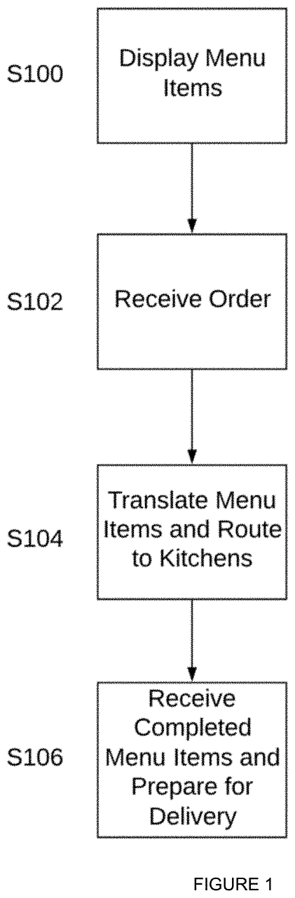

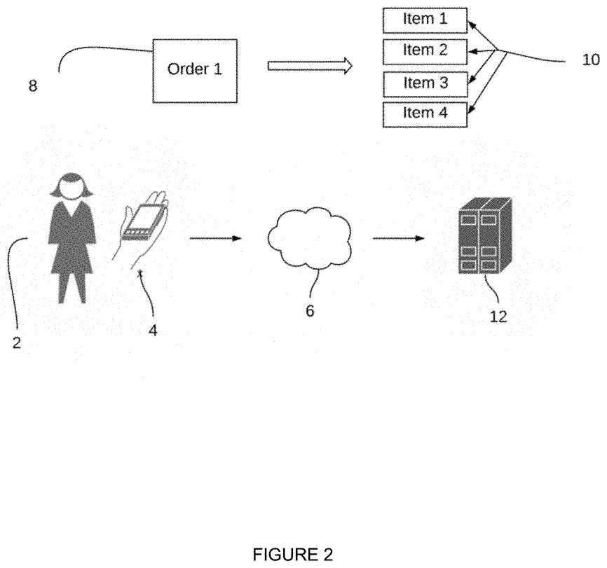

As shown in Step S100 of FIG. 1, a food menu listing items from one or more cuisines may be displayed to a user seeking to order food. The food menu may be communicated electronically via the system of the present disclosure, via one or more restaurants, or via a third-party online food delivery provider. In one non-limiting example, the restaurant may be called “Virtual Food Court” and the food menu may offer similar or disparate choices such as sushi, burgers, pizzas, and kebabs. As shown in FIG. 2, user 2 may access the food menu using electronic device 4 connected to communication network 6. Electronic device 4 may be a communication device, such as a computer, smartphone, tablet, or the like.

As shown in Step S102 of FIG. 1 and as further illustrated in FIG. 2, user 2 may use electronic device 4 to place food order 8 that may include one or more menu items 10 from the food menu provided. Order 8 may include additional relevant information, such as delivery and billing information, which in some aspects may be communicated directly or indirectly to server 12.

In one aspect of the system of the present invention, order 8 may be transmitted from user 2 to server 12 via network 6, then to kitchens for preparation. In another aspect, order 8 may be transmitted from user 2 to a third-party online delivery provider (not shown) that transmits order 8 through the network 6 server 12 and/or to kitchens. In this aspect, server 12 may be granted participating kitchens' login/password for third-party online deliver provider (directly or via API) and/or may read data from third-party online deliver provider displayed on an electronic device associated with the participating kitchen.

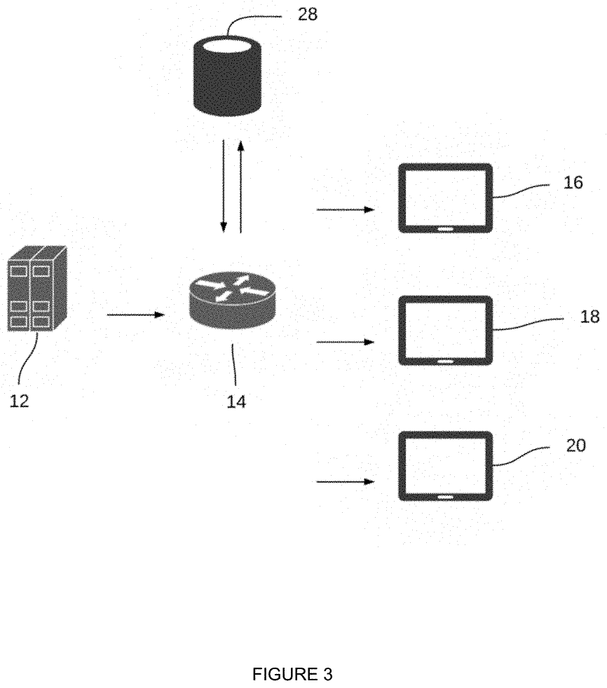

At Step S104, the system may translate one or more menu items 10 from order 8 in the event the name of the menu item ordered by the user does not match the name of the menu item used by the receiving kitchen. As shown in FIG. 3, server 12 may include or connect to router 14 that may include or connect to database containing a look up table 28. Look up table 28 may link menu items offered to the user (e.g., “Virtual Food Court” menu items) with menu items of the receiving kitchen, so the food preparer at the receiving kitchen will better understand what food item to prepare. It will be understood by those skilled in the art that other data structures may be used instead of or in combination with lookup table 28 to achieve the same or similar result. In Step S104, router 14 may then route order information to electronic devices 16, 18, and 20 resident and/or associated with receiving kitchens. The menu items will be prepared for delivery at step S106 described in more detail below.

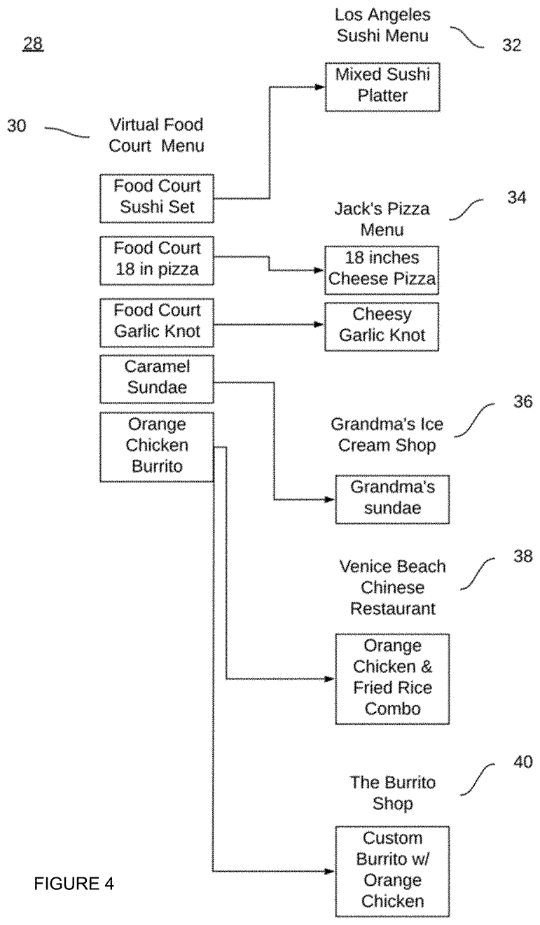

FIG. 4 illustrates the operation of lookup table 28 according to the ongoing example. In this example, Virtual Food Court Menu 30 is the menu presented to user 2. Order 8 contains the following five items 10: “Food Court Sushi Set”; “Food Court 18 in. pizza”; “Food Court Garlic Knot”; “Cheesy Garlic Knot”; and “Orange Chicken Burrito”. The ordered items 10 correspond to menu offerings of multiple kitchens that may be located in a multi-kitchen facility. As shown in FIG. 4, lookup table 28 shows “Food Court Sushi Set” corresponds to the item “Mixed Sushi Platter” on the menu of “Los Angeles Sushi”. Therefore, in response to this ordered item, lookup table 28 and router 14 may dispatch an order for “Mixed Sushi Platter” to the kitchen of “Los Angeles Sushi” 32, as explained in more detail below.

Similarly, router 14 and look-up table 28 may translate “Food Court 18 in. pizza” and “Food Court Garlic Knot” and dispatch an order for “18 inches Cheese Pizza” and “Cheesy Garlic Knot” to the kitchen of “Jack's Pizza” 34. Router 14 and look-up table 28 may translate “Caramel Sundae” and dispatch for “Grandma's sundae” to the kitchen of “Grandma's Ice Cream Shop” 36.

As shown in FIG. 4, “Orange Chicken Burrito” is a multi-kitchen item that is a combination of at least portions of two menu items, each made in a separate kitchen within the multi-kitchen facility. In this case, “Orange Chicken & Fried Rice Combo” is made by the kitchen of “Venice Beach Chinese Restaurant” 38 and “Custom Burrito w/Orange Chicken” is made by the kitchen of “The Burrito Shop” 40. When user 2 orders the “Orange Chicken Burrito”, server 12 may translate and route an item to both kitchens. “Venice Beach Chinese Restaurant” 38 may receive an order for “Orange Chicken & Fried Rice Combo” and optionally may receive a special instruction, e.g., to add to or modify the menu item because it will be used in combination at another kitchen. “The Burrito Shop” 40 may receive an order for “Custom Burrito w/Orange Chicken” along with a special instruction, e.g., to delay preparation until receipt of an item or one or more ingredients from another kitchen, in this case “Orange Chicken & Fried Rice Combo” from “Venice Beach Chinese Restaurant” 38 .

Once “Orange Chicken & Fried Rice Combo” is prepared in whole or in relevant part, “Venice Beach Chinese Restaurant” 38 may notify the system (as described further below). That food item may be tagged as a “multi-kitchen item” and may be transported to “The Burrito Shop” 40 where “Custom Burrito w/Orange Chicken” will be completed.

Regular food items and multi-kitchen items often have different completion times. For example, “18 inches Cheese Pizza” may take on average 20 minutes to prepare, while “Grandma's Sundae” may take 3 minutes to prepare. Therefore, the system may store preparation times and delay transmitting orders to kitchens to increase the likelihood the items are completed at or around the same time for outbound delivery. Other factors that may be stored and may affect transmission time include: identity of staff in the kitchen, kitchen staff average speed of completion of the item requested or items generally, length of queue of items per kitchen, estimated time of arrival of delivery driver, and others.

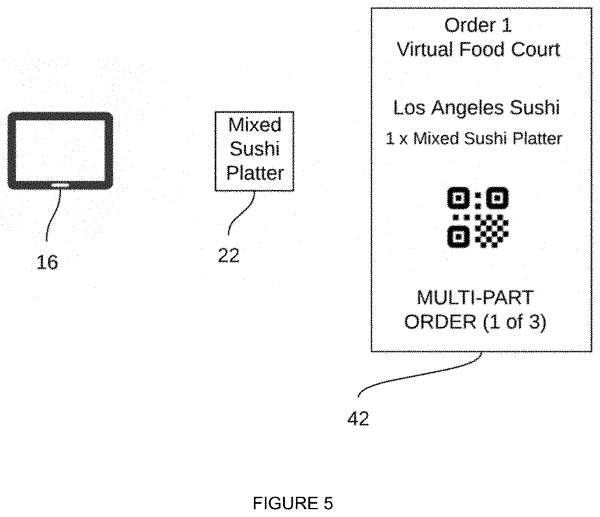

As shown in FIG. 5, kitchens may receive a notification to prepare a food item via a communication device, such as tablet 16 and/or via a printer (not shown) creating a printed ticket 42. The notification may include an order number; the name of the menu from which the order originated “Virtual Food Court”; the name of the receiving kitchen “Los Angeles Sushi”; food item details including the name or identifying information of the food item, e.g., “Mixed Sushi Platter”; a code for tracking purposes, such as a QR code; and an indication this is part of a multi-part order.

The staff of “Los Angeles Sushi” will understand this order is for “Virtual Food Court” and so may use a standard white un-branded packaging for this item or may use a “Virtual Food Court” branded packaging. Ticket 42 may be attached to the food once packaged for tracking purposes.

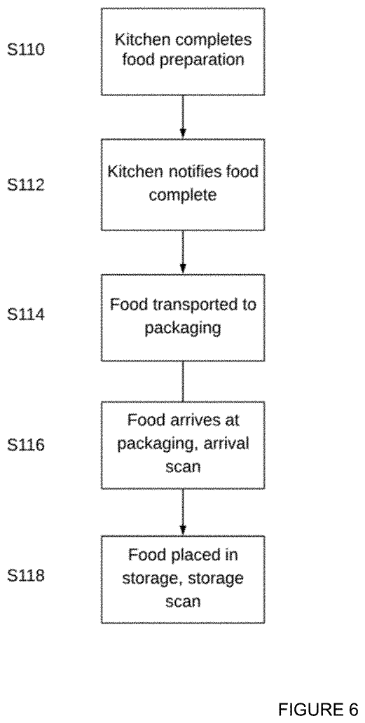

As shown in FIG. 6 in step S110, once the kitchen has prepared the food, the kitchen may notify the system the food is ready, e.g., via a digital button on the order management system on the communication device (step S112). The system may then trigger the food to be transported to an assembly area (step S114), e.g., via human or automated delivery. The kitchen staff may preferably attach ticket 42 that may include order information as well as the QR code for tracking and packaging purposes.

Once the food has arrived at the assembly area, the QR code on the physical ticket may be scanned by an electronic scanning device (step S116). The food may be placed in a storage space, such as shelf or bin, and a QR code for that storage space may be scanned to link the food to the storage space in the system (step S118). In another aspect, the system may indicate which storage space to place the food based on a characteristic of the order, food type, physical size, number of parts, food and/or ambient temperature, time to delivery. In the case of a multi-part order, when the second part of the food order arrives, the scan of the QR code for the second part of the order may notify an operator to place the second part of the order in or near the storage space occupied by the first part of the order.

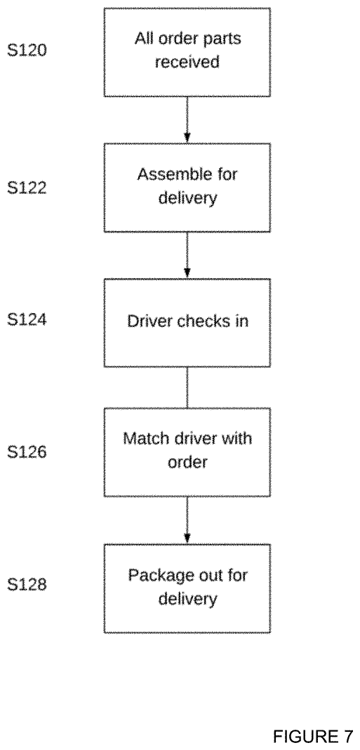

As shown in FIG. 7 in step S120, once the final part of an order has arrived in the assembly area, the system may trigger an operator (human or machine) to put all food items for that order into an outer bag, which may include a brand, such as “Virtual Food Court” (step S122).

When the delivery driver arrives (step S124), they will check-in to the system using a communication device. The driver may be notified that the order is ready (step S126). The driver may take physical possession of the order, and the system will be notified (step S128).

The online food delivery platform or the system of the present disclosure may receive payment for the food order. The system may reconcile payments to one or more participants including the kitchen(s), delivery platform, driver, and brand marketer (e.g., Virtual Food Court).

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor.

Embodiments of the present method steps may be performed by a programmable processor executing a program of instructions to perform functions of the described implementations by operating on input data and generating output. The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

As desired, embodiments of the disclosure may include a device with more or fewer components than are illustrated in the drawings. Additionally, certain components of the device may be combined in various embodiments of the disclosure. The devices described above are provided by way of example only.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

The operations described and shown in some figures may be carried out or performed in any suitable order as desired in various embodiments of the disclosure, and processes may repeat any number of times. Additionally, in certain embodiments, at least a portion of the operations may be carried out in parallel.

1. A method for processing a customer food order in a multi-kitchen environment, the method comprising the steps of:
a. receiving an order associated with the customer at an electronic device, the order comprising at least first and second food items;
b. translating an identifier of the first food item to a first corresponding identifier associated with a first kitchen and routing the first corresponding identifier to one or more electronic devices at the first kitchen;
c. translating an identifier of the second food item to a second corresponding identifier associated with a second kitchen and routing the second corresponding identifier to one or more electronic devices at the second kitchen;
d. receiving a notification from an electronic device that the first food item is located at one of a plurality of delivery storage locations; and
e. receiving a notification from an electronic device that the second food item is prepared for storage, and in response transmitting to one or more electronic devices the delivery storage location of the first food item.

2. The method of claim 1, further comprising:
f. receiving an alert from that an appropriate delivery driver is present; and
g. transmitting the delivery storage location of the first and second food items to an electronic device to assist pairing the first and second food items with the appropriate delivery driver.

3. The method of claim 1, further comprising, after step e:
receiving a notification from an electronic device that the second food item is located at the delivery storage location of the first food item.

4. The method of claim 1, further comprising, after step e:
receiving a notification from an electronic device that the first and second food items are outbound for delivery to the customer.

5. The method of claim 1, wherein the at least one electronic device in the first kitchen and second kitchen comprises one of a display device and a printer.

6. The method of claim 1, wherein step c) is delayed based on one or more of a time to complete preparation of one of the first and second food items, identity of staff in one of the first and second kitchens, length of queue of food items to be prepared in one of the first and second kitchens, and estimated time of arrival of delivery driver.

7. A method for processing a customer food order in a multi-kitchen environment, the method comprising:
a. receiving an order associated with the customer at an electronic device, the order comprising at least first and second food items;
b. translating an identifier of the first food item to a first corresponding identifier associated with a first kitchen and routing the first corresponding identifier to one or more electronic devices at the first kitchen;
c. translating an identifier of the second food item to a second corresponding identifier associated with a second kitchen and routing the second corresponding identifier to one or more electronic devices at the second kitchen;
d. receiving a notification from an electronic device that the first food item is prepared for storage;
e. transmitting a storage location for the first food item to one or more electronic devices; and
f. receiving a notification from an electronic device that the second food item is prepared for storage, and in response transmitting to one or more electronic devices the delivery storage location of the first food item.

8. The method of claim 7, wherein the storage location is selected based on one or more of a characteristic of at least one of the first and second food items, time of day, temperature, time of pickup, and time of delivery.

9. The method of claim 7, wherein the at least one electronic device in the first kitchen and second kitchen comprises one of a display device and a printer.

10. A method for processing a customer food order in a multi-kitchen environment, the method comprising:
a. receiving an order associated with the customer at an electronic device, the order comprising a food item;
b. translating an identifier of the food item to a first corresponding identifier associated with a first kitchen and routing the first corresponding identifier to one or more electronic devices at the first kitchen with instructions to prepare at least a portion of a first corresponding food item;
c. translating the identifier of the food item to a second corresponding identifier associated with a second kitchen and routing the second corresponding identifier to one or more electronic devices at the second kitchen with instructions to prepare at least a portion of a second corresponding food item;
d. notifying at least one electronic device in the second kitchen that the second kitchen will receive the first corresponding food item from another kitchen for incorporation with the second corresponding food item;
e. receiving a notification from at least one electronic device in the first kitchen that the first corresponding food item is prepared; and
f. notifying at least one electronic device in the second kitchen of the arrival of the first corresponding food item at the second kitchen.

11. The method of claim 10, wherein one or more of steps c) and d) are performed based on an estimated time to complete preparation of one of the first corresponding food item and the second corresponding food item.

12. The method of claim 10, wherein one or more of steps c) and d) are triggered by step e).

13. The method of claim 10, wherein the at least one electronic device in the first kitchen and second kitchen comprises a display device and a printer.

14. The method of claim 10, further comprising:
g. receiving a notification from an electronic device that the food item is located at one of a plurality of delivery storage locations.
